(19) United States
(12) Patent Application Publication
(10) Pub. No.: US 2003/0208346 A1
(43) Pub. Date: Nov. 6, 2003

(54) Block characterization of RC network using AWE(asymptotic waveform evaluation)

(76) Inventor: Andy Huang, San Jose, CA (US)

Correspondence Address: ANDY HUANG, 2880 ZANKER ROAD, SUITE 203, SAN JOSE, CA, 95134, US

(21) Appl. No.: 10/063,625

(22) Filed: May 3, 2002

(51) Int. Cl. G06F 17/50

(52) U.S. Cl. 703/14

(57) ABSTRACT

Technique to improve circuit level simulation speed through the block characterization of the RC network based on the AWE (Asymptotic Waveform Evaluation) is proposed. Since the numbers of RC network of the recent VLSI circuit becomes huge, the complexities of them are the most difficult and time-consuming task in the circuit verification. In addition to the increasing size of the RC networks, the accuracy is another big concern in the circuit simulation and verification. To have the speed while maintaining the accuracy in the circuit simulation, abstraction by block characterization is devised, implemented, and benchmarked. It first extracts transfer equation from the complex RC networks by applying AWE, modeled them as simple π-model, then find effective capacitance. The effective capacitance is modeled as pin capacitance of the input of the block, the transfer equation is modeled as a function of the between pins in the block. Converting the RC network into block and computing matrix with block, instead of RC network, can reduce the time to solve the matrix by the two orders of time while keeping the accuracy.

### CROSS REFERENCE TO RELATED APPLICATIONS

L. T. Pillage and R. A. Rohrer, “Asymptotic Waveform Evaluation for Timing Analysis,” IEEE Trans. on Computer-Aided Design, vol. 9, no. 4, pp. 352-366, April, 1990. [2] J. Qian, S. Pullela, and L. Pillage, “Modeling the” “Effective Capacitance” “for the RC Interconnect of CMOS Gates,” IEEE Trans. on Computer-Aided Design, vol. 13, no. 12, pp. 1526-1535, December 1994. [3] C. L. Ratzlaff and L. T. Pillage, “RICE: Rapid Interconnect Circuit Evaluation Using AWE,” IEEE Trans. on Computer-Aided Design, vol. 13, no. 6, pp. 763-776, June, 1994.

### BACKGROUND OF INVENTION

There are lots of researches on the circuit simulation more than a few decades, but still lots of difficulties in their area. Even in the deep sub-micron and system on a chip era, new phenomenon, such as parasitic effect of the interconnect, signal integrity, ground bounce, etc, cannot be ignored any more. Due to interconnect length, cross effect between them, and delay in the VLSI design, RC value and effect become major consideration in the circuit simulation area. Parasitic RC of the interconnection is one of the major reason to slow down the speed of the circuit simulation.

To speed up the circuit simulation, there has been several techniques are applied. Breaking the circuit into smaller block, solve them separately, and integrated to find the whole circuit behaviors. Or, instead finding solution from corresponding equation of the device, modeling technique is applied to find solution more quickly. Or, array structure is mapped into the macro modeling to speed up. Recently, the modeling of interconnect has big attention and is researched deeply.

This invention introduces block characterization technique to be applied at the circuit simulation, and it is simple but it has abilities that can have the two orders of magnitudes speedup in simulation time. Instead of single and big matrix, each of elements is partitioned into smaller matrix, and the circuit simulation can solve the small matrix with ease and fast. Therefore, each of the RC networks of the interconnect is treated as primitive cell of the circuit.

### BRIEF DESCRIPTION OF DRAWINGS

Picture 1 describes the procedure of the block characterization technique.

FIG. 2 π-model

FIG. 3: Characterized Block

### DETAILED DESCRIPTION

Block Characterization Technique

Behind the block characterization, the asymptotic waveform evaluation (AWE) technique is adopted. AWE by Pillage[1] performed qth order Pad é approximation method. The accuracy of the approximation is determined by the reduced order, q value, and the user defines the q value. The brief introduction of AWE is as follows.

There is a state equation, which represents impulse response between two-circuit elements

The Laplacian Equation is

it can be represented by the equation (2).

The mᵢ of equation 2 represents momentum. The equation 2 converted by the pole-residue by the qth order Pad é approximation.

The relation among pole (Pᵢ), residue (kᵢ), and momentum are defined as follows.

At the equation 4, momentum is solved by the DC analysis, then a(i) is found. Afterwards, pole and residue k are found by the equations. As in the [1], finding momentum effectively is done by the path tracing algorithm. By this AWE technique, each of the transfer equations between nodes, circuit elements, is found and effective capacitance value of the input of RC network is computed.

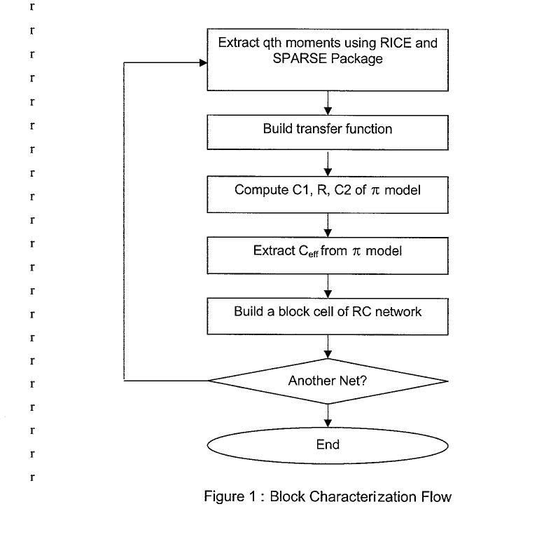

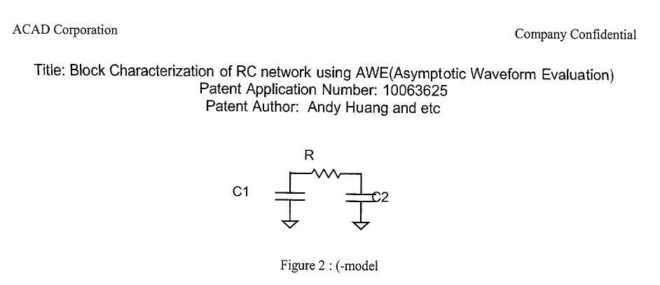

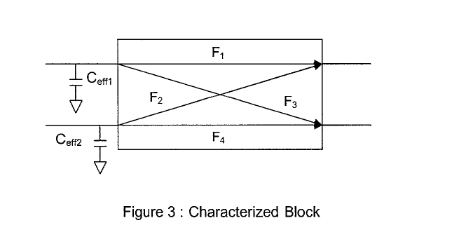

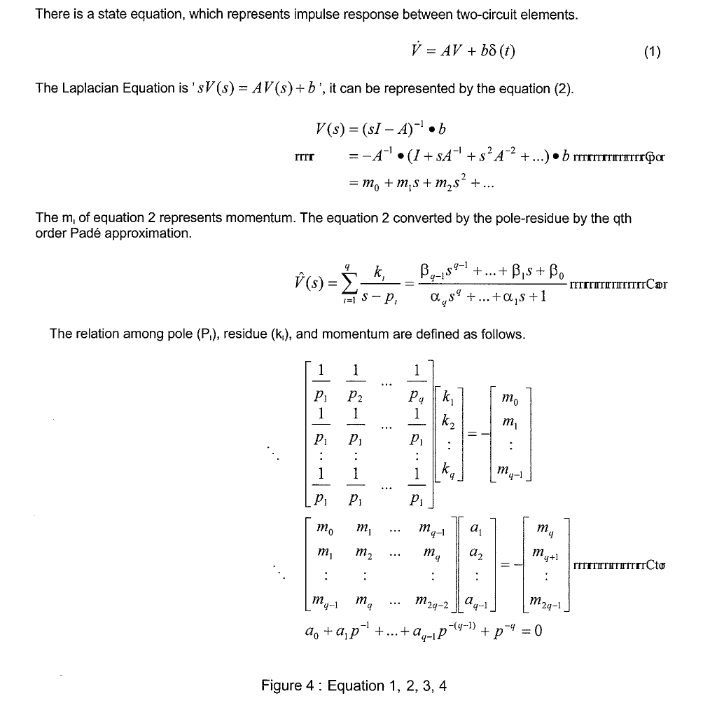

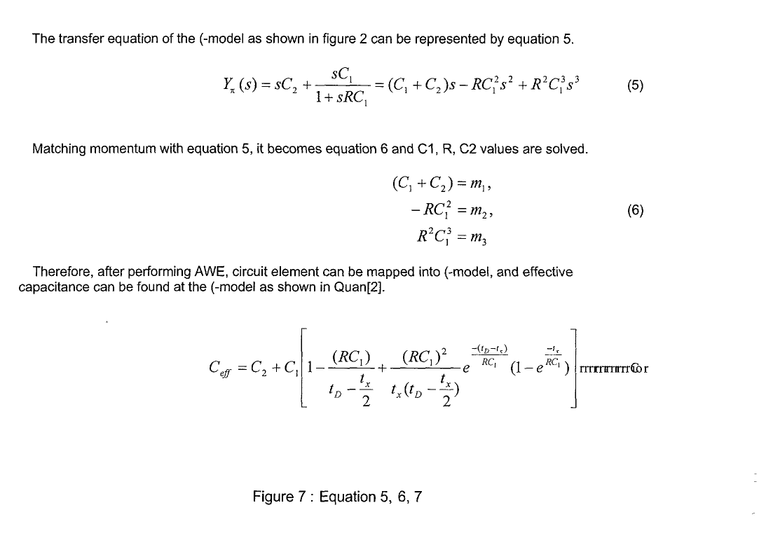

The transfer equation of the π-model as shown in FIG. 2 can be represented by equation 5.

Matching momentum with equation 5, it becomes equation 6 and C1, R, C2 values are solved.

Therefore, after performing AWE, circuit element can be mapped into π-model, and effective capacitance can be found at the π-model as shown in Quan[2].

At the equation 7, t_{D} and tₓ represents propagation delay and the time to reach 20% of output value, respectively. Initial value of the t_{D} and tₓ are not assigned. At first, the total capacitance value is assigned to the C_{eff}, and t_{D} and tₓ are obtained from the equation. The t_{D} and tₓ are applied again to get the C_{eff} until they converge. Following procedure is applied to model the block after we have the effective capacitance and transfer equation of RC network.

1. Inputs and outputs of the block: Input nodes and outputs nodes of RC network, respectively

2. Input pin capacitance of the block: C_{eff} of the RC network

3. Initial values of the inputs and outputs: the net values of the pair, linked with the directed edge, are assigned as the same logic level. It is called positive unate relative between input and output.

4. Path delay: time domain response of RC network.

Each of the input and output of the block is the same as each of input and output of the RC network, respectively. The value of the C_{eff} becomes the value of the capacitance of the input pin. Since the all of the phase are the same, all the values linked with the directed edge are assigned as positive unate values. Each delay value of the directed edge is time domain pin-to-pin response function. Therefore, these approach makes the block characterization is almost the same as the standard cell modeling. By these techniques, the RC network can be modeling as standard cell and speed up the simulation by two orders of magnitude in time at least.

1. The method of characterization consists of four steps. At first, find momentum by analyzing the RC network. The momentum can be computed by the path-tracing technique, reference [3], and the time for finding momentum increase linearly as the circuit complexity glows. To enable linear time bound as circuit complexity grows, the tree structure was adopt at the RC network. Some of the RC networks are traversed to find the momentum, and the others that cannot be represented by the tree are solved by DC analysis using the sparse package repeatedly. At second step, the reduced order transfer equation is found by the pole and residue based on the momentum, which is from the step 1. At the third step, the moments are converted to the each of their matched π-model network. At the fourth step, the effective capacitance value is computed from the π-model network. At the fifth step, each of the values from the each of the step is assign to the block. The effective capacitance value, evaluate at the step four, becomes the input capacitance of the block, the transfer equation that was evaluated at the second step is mapped into the delay of the gate. These characterization operations reduce the simulation time dramatically by removing the elements of the matrix, which is the inevitable and time-consuming mathematical representation and computation to do circuit simulation. Another words, the output value can be computed by the transfer equation instead of time-consuming matrix operation.
